(19) United States
(12) Patent Application Publication
(10) Pub. No.: US 2015/0131401 A1
(43) Pub. Date: May 14, 2015

(54) DEVICE FOR TRANSPORTING VISCOUS COMPOUNDS AND PASTES

(71) Applicant: LIST HOLDING AG, Arisdorf (CH)

(72) Inventor: Daniel Witte, Grenzach-Wyhlen (DE)

(21) Appl. No.: 14/396,262

(22) PCT Filed: Apr. 19, 2013
(86) PCT No.: PCT/EP2013/058143

§ 371 Date: Oct. 22, 2014

(30) Foreign Application Priority Data
Apr. 24, 2012 (DE) 10 2012 103 565.2

(51) Int. Cl. B29B 7/80; B29B 7/40

(52) U.S. Cl. CPC B29B 7/802; B29B 7/40
USPC 366/98

(57) ABSTRACT

A device for the controlled transport of viscous compounds and pastes in at least one process space (8) by at least one shaft (2), on which transport bars (4) are arranged and which rotates about a shaft axis (A), wherein centre axes (B) of the transport bars (4) run at an angle (7) with respect to the shaft axis (A), the centre axes (B) of transport bars (4.1, 4.2, 4.3) which follow one another in the direction of the shaft axis (A) should run offset in the circumferential direction with respect to one another and with respect to the shaft axis (A).

### BACKGROUND OF THE INVENTION

The invention relates to a mixing kneader.

In process technology, stirred containers for reaction control or for thermal processes have been customary for a long time. If the stirred vessel is operated continuously, it is desirable for it to be possible to set the level of filling in the stirred vessel, since the pressure vessel can otherwise be overfilled or underfilled, or the starting material or product would be subjected to different dwell times in the stirred vessel. The setting of the level of filling takes place gravimetrically either via a weir, over which the product flows, or by means of a pump solution with a filling level probe.

In the case of viscous compounds or pastes, the gravimetric filling level control does not function, since the stirrer has to be configured in such a way that it forcibly delivers the product or starting material. Here, the forces which are produced during the forced conveying are greater than the gravitational forces and are therefore definitive for how high the filling level is in the stirred vessel. A customary example is a conveying screw, as disclosed, for example, in DE 15 57 167 A1. In the case of the latter, the product is pressed against the vessel wall, against which it rubs. The screw flank then pushes the product which is impeded by the wall friction in the direction of the conveying direction of the screw. The filling level of a construction of this type is defined by the nominal conveying quantity of the screw and the rotational speed thereof. The nominal conveying quantity of the screw can be calculated for given screw geometries. The filling level can therefore be modified in the screw by way of variation of the rotational speed thereof.

It is one disadvantage of the conveying screw that the conveying rate increases quadratically with the diameter of the screw. If a large stirred vessel is to be constructed, this means that the screw pitch has to be very small, in order to set a high filling level. The shaft therefore becomes very voluminous and heavy, above all if it is to be self-cleaning, as is the case in some twin-shaft screws. As an alternative, the rotational speed has to be decreased greatly, which greatly restricts the stirring performance of the stirred vessel.

If the filling level in the screw space is to be increased additionally, the return flow can be backed up from the rear side. The screw then fills up completely upstream of the backing-up point, with the result that a return flow occurs in the screw. The return flow and the conveying rate which is increased by way of the increased filling level balance one another out exactly. The screw then builds up pressure in the conveying direction in accordance with the pressure gradient of the back current, which pressure counteracts the backing up. An increased filling level is therefore achieved in the screw, which increased filling level is inhomogeneous, however, since there is a low filling level in the intake region, but 100% of the screw is filled over a defined length upstream of the backing-up point. As a result of this method, a very large quantity of energy is also dissipated into the product.

The screw can then be constructed in such a way that it builds up pressure more efficiently, by the shear gaps being reduced. A smaller mechanical power loss is then produced. In this way, however, the region of the 100% filled screw becomes shorter and the aim of more efficient filling level regulation is again not met.

In order to improve the situation of the filling level regulation, large-volume kneaders (called kneaders in the following text) have been developed. Devices of this type are also called mixing kneaders. They serve for a very wide variety of purposes. The first to be mentioned is evaporation with solvent recovery, which takes place batchwise or continuously and also often under vacuum. As a result, for example, distillation residues and, in particular, toluene diisocyanates are treated, but also production residues with toxic or high boiling solvents from chemistry and pharmaceutical production, wash solutions and paint sludges, polymer solutions, elastomer solutions from solvent polymerization, adhesives and sealing compounds.

By way of the apparatuses, furthermore, continuous or batchwise contact drying of water-wetted and/or solvent-wetted products is carried out, likewise often under vacuum. The application is intended, above all, for pigments, dyestuffs, fine chemicals, additives, such as salts, oxides, hydroxides, antioxidants, temperature-sensitive pharmaceutical and vitamin products, active substances, polymers, synthetic rubbers, polymer suspensions, latex, hydrogels, waxes, pesticides and residues from chemical or pharmaceutical production, such as salts, catalysts, slag and waste lyes intended. Said methods are also used in food production, for example in the production and/or treatment of block milk, sugar substitutes, starch derivatives, alginates, for treating industrial sludges, oil sludges, biological sludges, paper sludges, paint sludges and in general for treating tacky, crusty viscously pasty products, waste products and cellulose derivatives.

Degassing and/or devolatilizing can take place in mixing kneaders. This is applied to polymer melts, after the condensation of polyester or polyamide melts, to spinning solutions for synthetic fibers and to polymer or elastomer granules or powder in the solid state.

A polycondensation reaction can take place in a mixing kneader, usually continuously and usually in the melt, and is used, above all, in the treatment of polyamides, polyesters, polyacetates, polyimides, thermoplastics, elastomers, silicones, urea resins, phenolic resins, detergents and fertilizers.

A polymerization reaction can also take place, likewise usually continuously. This is applied to polyacrylates, hydrogels, polyols, thermoplastic polymers, elastomers, syndiotactic polystyrene and polyacrylamides.

Reactions solid, liquid and multi-phase reactions can take place very generally in the mixing kneader. This applies, above all, to back-reactions, in the treatment of hydrofluoric acid, stearates, cyanates, polyphosphates, cyanuric acids, cellulose derivatives, cellulose esters, cellulose ethers, polyacetyl resins, sulfanilic acids, copper phthalocyanines, starch derivatives, ammonium polyphosphates, sulfonates, pesticides and fertilizers.

Furthermore, reactions can take place in a solid/gaseous manner (for example, carboxylation) or a liquid/gaseous manner. This is used in the application of acetates, azides, Kolbe-Schmitt reactions, for example BON, sodium salicylates, parahydroxybenzoates and pharmaceutical products.

Liquid/liquid reactions take place in the case of neutralization reactions and transesterification reactions.

Dissolving and/or degassing in mixing kneaders of this type take place in the case of spinning solutions for synthetic fibers, polyamides, polyesters and celluloses.

What is known as flushing takes place in the treatment and/or production of pigments.

Solid-state post-condensation takes place in the production and/or treatment of polyesters and polyamides, continuous slurrying, for example in the treatment of fibers, for example cellulose fibers, with solvents, crystallization from the melt of from solutions in the treatment of salts, fine chemicals, polyols, alkoxides, compounding, mixing (continuously and/or batchwise) in the case of polymer mixtures, silicone compounds, sealing compounds, fly ash, coagulating (in particular, continuously) in the treatment of polymer suspensions.

Multi-functional processes can also be combined in a mixing kneader, for example heating, drying, melting, crystallizing, mixing, degassing, reacting—all of them continuously or batchwise. Polymers, elastomers, inorganic products, residues, pharmaceutical products, food products and printing inks are produced and/or treated by way of this.

Vacuum sublimation/desublimation can also take place in mixing kneaders, by way of which chemical precursors, for example anthraquinone, metal chlorides, organometallic compounds, etc. are purified. Furthermore, pharmaceutical intermediate products can be produced.

Continuous carrier gas desublimation takes place, for example, in the case of organic intermediate products, for example anthraquinone and fine chemicals.

A distinction is made substantially between single-shaft and two-shaft mixing kneaders. A single-shaft mixing kneader is described, for example, in EP 91 105 497.1 (EP 0 451 747 A1). Multiple-shaft mixing and kneading machine are is described in CH-A 506 322, EP 0 517 068 B, DE 199 40 521 A1 or DE 101 60 535. There, radial disk elements and axially oriented kneading bars which are arranged between the disks are situated on a shaft. Frame-shaped mixing and kneading elements engage between said disks from the other shaft. Said mixing and kneading elements clean the disks and kneading bars of the first shaft. The kneading bars on both shafts in turn clean the housing inner wall.

The shafts usually rotate in a horizontal arrangement in a housing, disk segments being arranged on the cylindrical core shaft. The shape of the disk segments is designed in such a way that they are interrupted such that segment empty spaces are produced, as a result of which the product can flow in the shaft direction. Conveying elements which are called bars or else transport bars are fastened on the disk segments.

In the case of single-shaft kneaders, static components are fastened in the housing, with the result that disk segments, bars and static components encounter one another regularly as a result of the kinematic movement of the shaft. In the case of multiple-shaft kneaders, the encounters take place between the disk elements and bars of the countershaft. The disk segments can be offset on the shaft and might have a defined shape which follows the kinematic movement of the countershaft. There are a multiplicity of geometric possibilities for constructing kneaders of this type.

The construction of the kneaders has historically been derived from screw machines. The flank edge of the bars has therefore been arranged in a flush manner, in a similar manner to screw apparatuses. In order that the kneader conveys in a desired direction, the bars are arranged on the disk segments at an angle which corresponds in terms of the concept to the flank angle of screw shafts. It is assumed that the conveying logic is similar to that of screw machines, even if it rapidly becomes clear that there are great differences. For instance, the possibility of achieving higher filling levels at more rapid rotational speeds is improved considerably in comparison with screw apparatuses. The filling level can be set from the rear side via a discharge screw conveyor, without the kneader being 100% filled in this region. In contrast, the filling level profile is quite homogeneous over the length and tends to rise linearly or fall, but never in an abrupt manner, unless the rheological properties of the product likewise change abruptly.

The flush arrangement of the bars therefore results from the analogy to the screw geometry, namely that wall friction is necessary for transport. The publication “Axial transport in kneader reactors”, Daniel U. Witte, Antec 2007, has been able to show that, in the case of viscous products, kneaders do not convey as a result of the wall friction, but rather as a result of the engagement of the bars and disk segments with the static components or the bars and disk segments of the countershaft. This model depicts a satisfactory first approximation of the conveying characteristics of kneaders. It is a practical model, the simplicity of which corresponds to the model of the nominal conveying quantity of screw apparatuses. The model explains the conveying behavior of the kneader in such a way that, in the case of a local filling level of a conveying chamber, the product escapes into empty spaces in the container space during the encounter of the kneading elements (also called engagement). Said empty spaces can be in the conveying chamber which lies upstream or the conveying chamber which lies downstream. A type of pulsing movement is produced which has a tendency to equalize the filling level over the length of the kneader. The local conveying capacity in the shaft direction is therefore dependent on the local filling level and has to be interpolated locally with the conveying capacity of the adjacent chambers, in order for it to be possible to determine the nominal conveying capacity of the kneader.

Setting of the bars with respect to the shaft axis is sufficiently well known from the prior art. This is disclosed, for example, in WO 2010/034446 A2, CH 506 322 A and DE 21 23 956 A1.

EP 1 714 694 likewise discloses transport bars which are set differently with respect to the shaft axis, individual transport bars even being of bent configuration, in order to make it possible for two product streams to meet.

EP 0 274 668 A1 has disclosed a kneading mixer, in which the transport bars can be arranged not only at a different angle with respect to the transport shaft but also offset differently with respect to one another.

It is an object of the present invention to improve previously known kneaders with regard to the product treatment and the conveying capacity and to configure them to be more flexible with regard to the product to be treated.

### SUMMARY OF THE INVENTION

The object is achieved by the features of the transport device of the present invention.

An important precondition of the transport model of the abovementioned publication is that the flush arrangement of the kneading or transport bars is not necessary for the conveying characteristic in the case of viscous compounds and pastes. This is influenced geometrically solely by way of the angle of attack of the bar. If this is the case, the angle of attack of the bars and the arrangement angle of the bars between disk rows which follow one another (what is known as the winding angle) can be decoupled. The subject matter of this invention is therefore, above all, arrangements, where the angle of attack and the winding angle are not identical. This has the advantage that the angle of attack can be determined according to a required conveying characteristic of the kneader and the winding angle can be determined, for example, according to a desired engagement force distribution over the rotational movement of the shaft.

It is envisaged to configure the angle of the transport bars with respect to the shaft axis to be different than the angle between the center points of the bars which follow one another along the shaft axis. The angle of attack which is formed by the individual transport bars with respect to the shaft axis can at least be partially different.

In the case of single-shaft kneaders, the winding angle and the angle of attack can be decoupled as desired. This does not result in a structural complication. In the case of multiple-shaft kneaders, it has to be noted that the engaging elements do not engage tangentially in the shaft movement, but rather dip into the shaft movement of the countershaft and exit again after a defined rotary angle. Rotation of the bars with respect to the winding of the shaft is therefore impossible if the kneader has been constructed with minimum plays between the rotating elements. According to the invention, this problem is solved in such a way that the bar is divided into at least two sections which in each case have the desired angle of bar attack, it being possible for the winding angle to be selected as desired. Here, the two bar halves of a mixing chamber which are mounted on disks which follow one another form one line, with the result that the play between the shaft elements is again at a minimum.

### BRIEF DESCRIPTION OF THE DRAWINGS

Further advantages, features and details of the invention result from the following description of preferred exemplary embodiments and using the drawing, in which:

FIG. 1 shows a diagrammatically illustrated cross section through a kneader;

FIG. 2 shows a partially illustrated developed view of transport bars;

FIG. 3 shows a partially illustrated developed view of another arrangement of transport bars for a kneader according to FIG. 1; and

FIG. 4 shows a partially illustrated developed view of a further exemplary embodiment of transport bars for a kneader according to FIG. 1.

### DETAILED DESCRIPTION

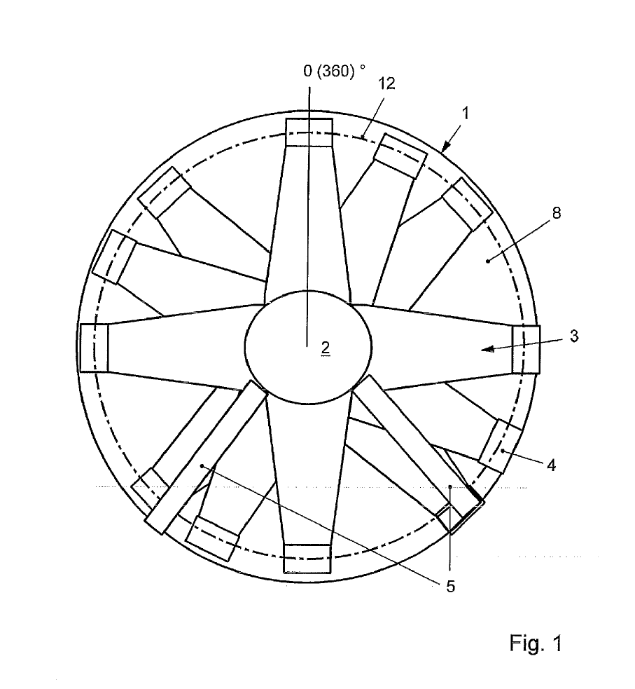

According to FIG. 1, a shaft 2 rotates in a housing 1, on which shaft 2 disk elements 3 are arranged. Transport bars 4 which wipe a housing inner wall are placed on said disk elements 3.

The transport bars 4 and disk elements 3 interact with static components 5 which protrude from the housing inner wall into a product space 8 against the shaft 2.

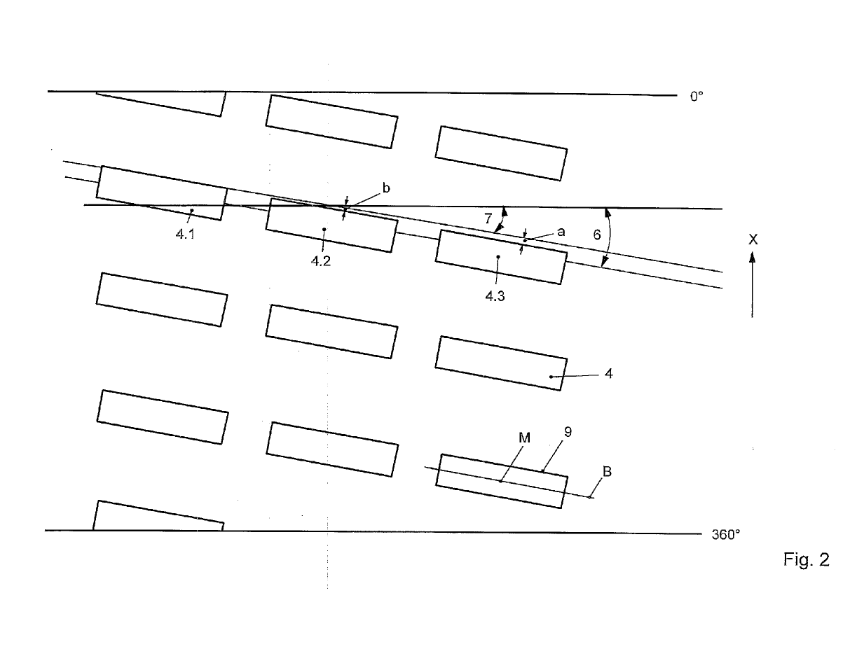

Using a dash-dotted line, 12 indicates a sectional plane with a viewing direction for the following FIGS. 2 to 4.

The shaft 2 rotates about a shaft axis A. Each transport bar 4 has a center axis B which runs through a center point M of the transport bar 4. The center axis B is set at an angle against the shaft axis A.

A surface 9 of the kneading bar 4 runs at an angle 7 which is to be called the conveying angle. In the exemplary embodiment according to FIG. 2, the surface 9 runs approximately parallel to the center axis B. However, the surfaces 9 of transport bars 4 which follow one another are arranged offset in each case in the circumferential direction by a defined amount a or b, with the result that they become active in the product at different times. It is to be emphasized here that the product space 8 in a kneader is filled only to a defined amount, whereas the remaining part is configured in a product-free manner as a free space. If, for example, the shaft 2 rotates in the direction of the arrow x, the transport bar 4.1 first of all emerges from the product, but then is the first to come into contact again with the product in the product space 8 after a certain rotation. It is followed in a time-delayed manner by the transport bar 4.2, and the latter is followed in turn in a time-delayed manner by the transport bar 4.3. As a result, both the product treatment and the conveying speed, and also the force absorption of the shaft are influenced.

6 otherwise denotes a winding angle. This is the arrangement angle of the bars between disk rows which follow one another. In the exemplary embodiment according to FIG. 2, the winding angle 6 corresponds to the conveying angle 7.

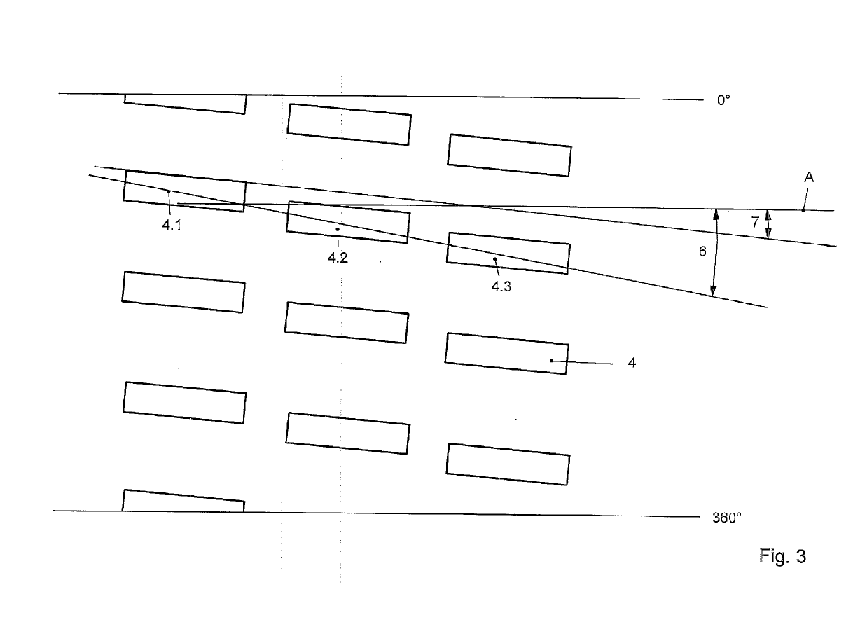

In contrast, this is different in FIG. 3, where the winding angle 6 is greater than the conveying angle 7. In this exemplary embodiment, the offsets of the individual transport bars 4.1, 4.2 and 4.3 are substantially greater.

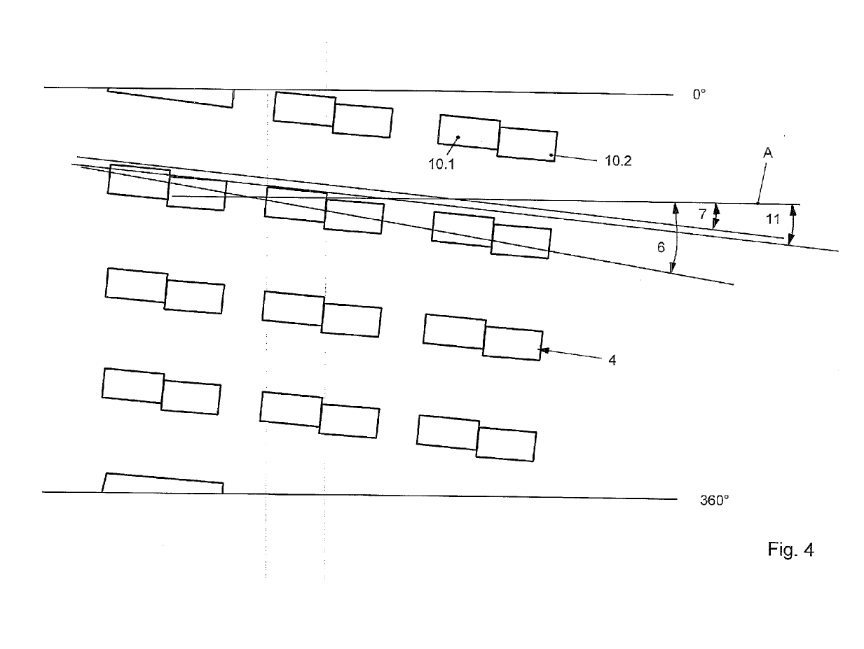

In the exemplary embodiment according to FIG. 4, each transport bar is divided into sections 10.1 and 10.2 which are arranged offset with respect to one another in a stepped manner. Here, the center axes of those sections which face one another of transport bars which follow one another have the same angle with respect to the shaft axis. The winding angle 6 and the conveying angle 7 are also indicated here, and furthermore also an angle 11 of two sections which face one another of transport bars which follow one another.

1-5. (canceled)

6. A kneader comprising:
a housing having an inner wall defining a processing space;
at least one shaft which rotates about an axis (A) in the processing space;
a plurality of disk elements mounted on the at least one shaft in a stepwise fashion along the shaft axis (A);
transport bars mounted on each disk element for wiping the inner wall of the housing, the transport bars each have a center axis (B) which extends at an angle (7) with respect to the shaft axis (A), wherein the transport bars are arranged in sections so as to follow one another in the direction of the shaft axis (A) and are offset from one another in a circumferential direction with respect to one another and to the shaft axis (A).

7. A kneader according to claim 6, wherein the sections have center axes which run at a winding angle (6) which is the same as angle (7) with respect to the shaft axis (A).

8. A kneader according to claim 7, further including static components which extend from the inner wall into the processing space and proximate to the shaft and interact with the transport bars.
